(19) United States
(12) Patent Application Publication
(10) Pub. No.: US 2026/0184596 A1
(43) Pub. Date: Jul. 2, 2026

(54) CATHODE ACTIVE MATERIAL FOR LITHIUM SECONDARY BATTERY, METHOD OF PREPARING THE SAME AND LITHIUM SECONDARY BATTERY INCLUDING THE SAME

(71) Applicants: SK ON CO., LTD., Seoul (KR); SK INNOVATION CO., LTD., Seoul (KR)

(72) Inventors: Sung Beom KIM, Daejeon (KR); Hyo Shik KIL, Daejeon (KR); Sang Bok KIM, Daejeon (KR); Sang Min PARK, Daejeon (KR); Jeong Bae YOON, Daejeon (KR)

(21) Appl. No.: 19/001,585

(22) Filed: Dec. 26, 2024

(30) Foreign Application Priority Data
Oct. 30, 2023 (KR) 10-2023-0146753

(51) Int. Cl. C01G 53/502; H01M 10/052

(52) U.S. Cl. CPC C01G 53/502; H01M 10/052; C01P 2002/74; C01P 2002/76; C01P 2004/03; C01P 2006/40; C01P 2006/80

(57) ABSTRACT

A cathode active material for a lithium secondary battery has a structure of a lithium-nickel-based oxide. A crystallite size in a (104) plane is in a range from 50 nm to 100 nm, and a slab ratio is in a range from 0.4 to 0.45. An active capacity of the cathode active material can be improved, and an elution amount of doping elements during washing process can be reduced, thereby improving capacity properties of a lithium secondary battery.

### CROSS-REFERENCE TO RELATED APPLICATION AND CLAIM OF PRIORITY

This application claims priority to Korean Patent Application No. 10-2023-0146753 filed on Oct. 30, 2023 in the Korean Intellectual Property Office (KIPO), the entire disclosure of which is incorporated by reference herein.

### TECHNICAL FIELD

The disclosure of this patent application relates to a cathode active material for a lithium secondary battery, a method of preparing the same and a lithium secondary battery including the same. More particularly, the present disclosure relates to a lithium metal oxide-based cathode active material for a lithium secondary battery, a method of preparing the same and a lithium secondary battery including the same.

### BACKGROUND

A secondary battery which can be charged and discharged repeatedly has been widely employed as a power source of a mobile electronic device such as a camcorder, a mobile phone, a laptop computer, etc., according to developments of information and display technologies. Recently, a battery pack including the secondary battery is being developed and applied as an eco-friendly power source such as an electric automobile.

Examples of the secondary battery include a lithium secondary battery, a nickel-cadmium battery, a nickel-hydrogen battery, etc. The lithium secondary battery among the secondary batteries is being actively developed due to high operational voltage and energy density per unit weight, a high charging rate, a compact dimension, etc.

The lithium secondary battery may include an electrode assembly including a cathode, an anode and a separator, and an electrolyte impregnating the electrode assembly. The lithium secondary battery may further include an outer material, e.g., a pouch-shaped outer material for housing the electrode assembly and the electrolyte.

As an application range of the lithium secondary battery expands to a large-scaled device such as the electric automobile, a high-nickel (High-Ni) lithium oxide having a high nickel content has been developed as a cathode active material for obtaining a high capacity. The cathode active material can be manufactured by reacting a nickel-containing precursor and a lithium source.

An unreacted residual lithium may remain on the cathode active material. The residual lithium may be removed through a washing process. However, the washing process may cause damages to a surface of the active material and deteriorate properties of the cathode active material.

### SUMMARY

According to an aspect of the present disclosure, there is provided a cathode active material for a lithium secondary battery having improved structural stability.

According to an aspect of the present disclosure, there is provided a method of preparing a cathode active material for a lithium secondary battery having improved structural stability.

According to an aspect of the present disclosure, there is provided a lithium secondary battery including the cathode active material for a lithium secondary battery and having enhanced life-span property.

A cathode active material for a lithium secondary battery has a structure of a lithium-nickel-based oxide. A crystallite size in a (104) plane defined by Equation 1 is in a range from 50 nm to 100 nm, and a slab ratio defined by Equation 2 is in a range from 0.4 to 0.45.

$${L}_{104} = \frac{K λ}{{β}_{104} cos θ} \qquad [ Equation 1 ]$$

In Equation 1, L₁₀₄ represents the crystallite size (nm) in the (104) plane, K represents a shape coefficient, λ represents an X-ray wavelength (nm), β₁₀₄ represents a full width at half maximum (rad), and θ represents a diffraction angle (rad) of a peak of the (104) plane from an X-ray diffraction (XRD) analysis.

$$slab ratio = ( thickness of TM slab ) / \{ ( Thickness of Li slab ) + ( thickness of TM slab ) \} \qquad [ Equation 2 ]$$

In Equation 2, TM represents a transition metal, the TM slab is an O-TM-O layer measured by a Rietveld method in a space group R-3m crystal structure by the XRD analysis, and the Li slab is an O—Li—O layer measured by the Rietveld method in the space group R-3m crystal structure by the XRD analysis.

In some embodiments, the slab ratio may be in a range from 0.42 to 0.44.

In some embodiments, the lithium-nickel oxide may have a layered structure or crystal structure represented by Chemical Formula 1-1.

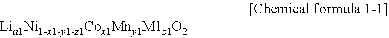

In Chemical Formula 1-1, M1 includes at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. 0.98<a1<1.03, 0.02≤x1≤0.15, 0≤y1≤0.15 and 0≤z1≤0.1.

In some embodiments, in Chemical Formula 1-1, 0.05<x1≤0.15 and 0<y1≤0.1.

In some embodiments, in Chemical Formula 1-1, x1>y1.

In some embodiments, the thickness of the TM slab may be 2.10 Å or more and less than 2.13 Å.

In some embodiments, the thickness of the Li slab is 2.59 Å to 2.77 Å.

In some embodiments, a ratio of a peak intensity of a (003) plane to a peak intensity of the (104) plane by the XRD analysis may be in a range from 2 to 3.

In some embodiments, a ratio of a peak intensity of a (003) plane to a peak intensity of the (104) plane by the XRD analysis may be greater than 2.2 and 2.5 or less.

In some embodiments, the lithium-nickel-based oxide may include a doping element including at least one of Ba, S, Sr, B and W.

A lithium secondary battery includes a cathode including a cathode active material layer that includes the above-described cathode active material for a lithium secondary battery, and an anode facing the cathode.

In a method for preparing a cathode active material for a lithium secondary battery, a lithium source and a transition metal precursor having a crystallite size in a (001) plane defined by Equation 3 of 20 nm to 100 nm are reacted to form a preliminary lithium-nickel-based oxide. The preliminary lithium-nickel-based oxide is calcined to form a lithium-nickel-based oxide.

$${L}_{001} = \frac{K λ}{{β}_{001} cos θ} \qquad [ Equation 3 ]$$

In Equation 3, L₀₀₁ represents the crystallite size (nm) in the (001) plane, K represents a shape coefficient, λ represents an X-ray wavelength (nm), B₀₀₁ represents a full width at half maximum (rad), and θ represents a diffraction angle (rad) of a peak of the (001) plane from an X-ray diffraction (XRD) analysis.

In some embodiments, the transition metal precursor may include a compound represented by Chemical Formula 2.

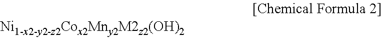

In Chemical Formula 2, M2 includes at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. 0.02≤x230.15, 0≤y2≤0.15 and 0≤z2≤0.1.

In some embodiments, washing and drying the lithium-nickel-based oxide may be further performed.

In some embodiments, the lithium-nickel-based oxide may include a doping element including at least one of Ba, S, Sr, B and W. A ratio of a weight of the doping element in the lithium-nickel-based oxide before the washing and drying to a weight of the doping element in the lithium-nickel-based oxide after the washing and drying may be 0.5 or more.

In some embodiments, a molar ratio of the transition metal precursor to the lithium source input in the formation of the preliminary lithium-nickel-based oxide may be in a range from 0.98 to 1.03.

In some embodiments, a crystallite size in a (104) plane defined by Equation 1 of the lithium-nickel-based oxide may be in a range from 50 nm to 100 nm.

$${L}_{104} = \frac{K λ}{{β}_{104} cos θ} \qquad [ Equation 1 ]$$

In Equation 1, L₁₀₄ represents the crystallite size (nm) in the (104) plane, K represents a shape coefficient, λ represents an X-ray wavelength (nm), β₁₀₄ represents a full width at half maximum (rad), and θ represents a diffraction angle (rad) of a peak of the (104) plane from the XRD analysis.

In some embodiments, a slab ratio defined by Equation 2 of the lithium-nickel-based oxide may be in a range from 0.4 to 0.45.

$$slab ratio = ( thickness of TM slab ) / \{ ( Thickness of Li slab ) + ( thickness of TM slab ) \} \qquad [ Equation 2 ]$$

In Equation 2, TM represents a transition metal, the TM slab is an O-TM-O layer measured by a Rietveld method in a space group R-3m crystal structure by the XRD analysis, and the Li slab is an O—Li—O layer measured by the Rietveld method in the space group R-3m crystal structure by the XRD analysis.

A cathode active material for a lithium secondary battery according to embodiments of the present disclosure may have a predetermined size and increased specific surface area. Accordingly, an active capacity of a cathode may be enhanced.

In some embodiments, the cathode active material may have crystal properties capable of suppressing an interaction between transition metals and an elution of doping elements. Thus, capacity properties of the lithium secondary battery may be improved.

In the preparation of the cathode active material for a lithium secondary battery according to example embodiments of the present disclosure, a transition metal precursor having a predetermined size may be used. Accordingly, a plate-shaped transition metal precursor having improved crystallinity may be formed, so that structural stability of the cathode active material may be improved.

A lithium secondary battery according to example may include the cathode active material for a lithium secondary battery to have improved life-span and capacity properties.

### BRIEF DESCRIPTION OF THE DRAWINGS

FIGS. 1A and 1B are schematic diagrams illustrating a crystal structure of a cathode active material in accordance with example embodiments.

FIG. 2 is a schematic diagram of a crystal structure of a transition metal precursor in accordance with example embodiments.

FIG. 3A and FIG. 3B are scanning electron microscopy (SEM) images showing a transition metal precursor according to example embodiments and a transition metal precursor according to a comparative example, respectively.

FIG. 4 and FIG. 5 are a schematic plan view and a schematic cross-sectional view, respectively, illustrating a lithium secondary battery in accordance with example embodiments.

### DETAILED DESCRIPTION OF THE EMBODIMENTS

According to embodiments of the present disclosure, a cathode active material for a lithium secondary battery including a lithium-nickel-based oxide particle and a method of preparing the cathode active material are provided.

Further, a lithium secondary battery including the cathode active material and having improved life-span and capacity properties are also provided.

Hereinafter, embodiments of the present disclosure will be described in detail with reference to embodiments and examples, and the accompanying drawings. However, those skilled in the art will appreciate that such embodiments and drawings are provided to further understand the spirit of the present invention and do not limit subject matters to be protected as disclosed in the detailed description and appended claims.

A cathode active material for a secondary battery (hereinafter, that may be abbreviated as a cathode active material) according to embodiments of the present disclosure may include a lithium-nickel-based oxide.

In some embodiments, the cathode active material may further contain cobalt (Co) as a transition metal and may further contain manganese (Mn). For example, the cathode active material may include a nickel-cobalt-manganese (NCM)-based lithium oxide.

As a content of the transition metal in the lithium-nickel-based oxide increases, life-span properties and power stability of a cathode or the secondary battery may be relatively deteriorated. For example, as a content of Ni in the lithium-nickel-based oxide increases (or a content of Co decreases), structure of the cathode active material may become unstable, thereby deteriorating the life-span and power properties.

For example, as a content of the transition metal increases, an elution amount of doping elements in a washing process for removing a residual lithium in a production of the cathode active material may be increased, thereby deteriorating the life-span properties. Additionally, a cation mixing in which a transition metal (e.g., Ni) is substituted for lithium (Li) of the cathode active material, thereby suppressing a movement of Li may occur.

However, a crystal size of the lithium-nickel-based oxide, or a ratio of a thicknesses of a TM slab and a Li slab may be controlled to reduce the elution amount of the doping elements, and the cation mixing ratio may be suppressed.

The TM slab is a transition metal layer or an O-TM-O layer in an octahedral structure (TMO₆) containing a transition metal (TM) obtained by an X-ray diffraction (XRD) Rietveld Refinement analysis.

A Li slab is a lithium layer or O—Li—O layer in an octahedral structure (LiO₆) containing Li obtained by the XRD Rietveld analysis.

The TM slab and the Li slab may be obtained from a crystal structure analysis by the Rietveld method when the space group R-3m is used in a crystal structure model based on the XRD analysis.

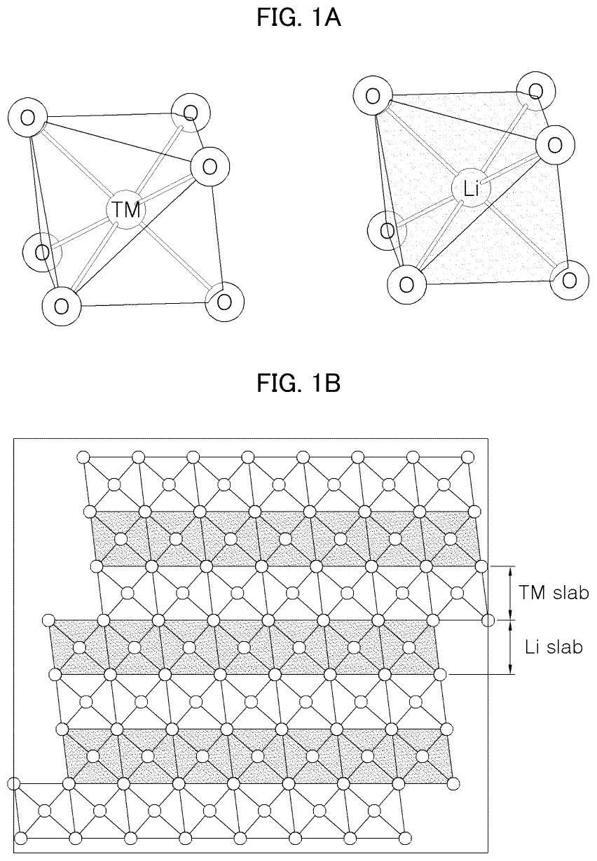

FIG. 1A and FIG. 1B are schematic diagrams of the crystal structure of the cathode active material according to example embodiments. In FIG. 1A, the transition metal included in the TM slab is indicated as TM.

Referring to FIG. 1A, a unit lattice of the TM slab may have an octahedral shape in which six oxygen atoms surround the transition metal TM. A unit lattice of the Li slab may also have an octahedral shape in which six oxygen atoms surround a lithium atom. During a reaction between a cathode active material precursor and a lithium source, lithium ions may be doped or intercalated to form a lithium layer.

Referring to FIG. 1B, the unit lattice of the TM slab may be stacked on the same layer to form the TM slab. Further, the unit lattice of the Li slab may be stacked on the same layer to form the Li slab. The TM slab and the Li slab may be stacked to form a cathode active material crystal.

The cathode active material for a lithium secondary battery according to embodiments of the present disclosure may have a crystallite size in a (104) plane defined by Equation 1 in a range from 50 nm to 100 nm, 60 nm to 100 nm, or 70 nm to 100 nm.

$${L}_{104} = \frac{K λ}{{β}_{104} cos θ} \qquad [ Equation 1 ]$$

In Equation 1, L₁₀₄ represents the crystallite size (nm) in the (104) plane, K represents a shape coefficient, λ represents an X-ray wavelength (nm), β₁₀₄ represents a full width at half maximum (rad) and 0 represents a diffraction angle (rad) of a peak of the (104) plane from the XRD analysis. The shape coefficient (K) may be, e.g., 0.8.

When the crystallite size in the (104) plane of the cathode active material is less than 50 nm, accessibility of lithium ions may be degraded, and capacity and life-span properties of the cathode may be lowered.

When the crystallite size in the (104) plane of the cathode active material exceeds 100 nm, primary particles forming a secondary particle may be grown and combined with each other to reduce a specific surface area of the cathode active material. Accordingly, capacity and power properties of the cathode may be lowered.

In some embodiments, the cathode active material for a lithium secondary battery may have a crystallite size as defined by Equation 1 above in a range from 70 nm to 95 nm, or from 75 nm to 95 nm. In the above range, the capacity, life-span and power properties of the cathode may be further improved.

A slab ratio as defined by Equation 2 below of the cathode active material for a lithium secondary battery according to embodiments of the present disclosure may be in a range from 0.4 to 0.45, or from 0.42 to 0.45.

When the slab ratio is less than 0.4, intercalation and deintercalation of lithium may be facilitated at an initial phase of charging/discharging, and thus the power properties may be improved. However, possibility that nickel ions present in the TM slab are transferred to the Li slab may be increased. The cation mixing may occur due to a continuous entry of nickel ions into the Li slab, and the hexagonal crystal structure may be collapsed. Accordingly, the capacity and life-span properties of the lithium secondary battery may be degraded.

When the slap ratio exceeds 0.45, an elution amount of the transition metal may be increased during production of the cathode active material or operation of the cathode, and the cation mixing ratio may be increased. Accordingly, intercalation and deintercalation of lithium may be hindered, and the power properties may be degraded.

slab ratio=(thickness of TM slab)/{(thickness of Li slab)+(thickness of TM slab)} [Equation 2]

In some embodiments, the thickness of the TM slab thickness measured by the Rietveld method in a space group R-3m crystal structure model by an XRD analysis of the cathode active material for a lithium secondary battery may be 2.1 Å or more and less than 2.13 Å, 2.11 Å or more and less than 2.13 Å, or 2.115 Å or more and less than 2.13 Å.

In the above range, the thickness of the TM slab may be prevented from becoming excessively small. Further, inhibition of an interaction between the transition metals caused when a distance between the transition metal and oxygen (O) in the TM slab becomes small may be prevented.

For example, when the thickness of the TM slab is reduced, the intercalation and deintercalation of lithium may be facilitated at an initial phase of charge/discharge, thereby improving power properties. However, the probability that nickel ions existing in the TM slab are transferred to the Li slab may be increased. Accordingly, the nickel ions may continuously enter and exit the Li slab to cause a cation mixing, and microcracks and macrocracks in an internal structure of the active material and collapse of the hexagonal crystal structure may occur.

According to embodiments of the present disclosure, the thickness of the TM slab may be maintained in the above range, so that the above-described defects and deformation of the crystal structure may be suppressed.

In some embodiments, the slab ratio defined by the above Equation 2 may be in a range from 0.42 to 0.44, or from 0.43 to 0.44. In the above range, the cation mixing ratio between the transition metal and the lithium ions may be suppressed, and the capacity and life-span properties may be further improved.

In some embodiments, the thickness of the Li slab measured by the Rietveld method in the space group R-3m crystal structure model by the XRD analysis of the cathode active material for a lithium secondary battery may be in a range from 2.59 Å to 2.77 Å, 2.59 Å to 2.75 Å, 2.59 Å to 2.72 Å, from 2.59 Å to 2.70 Å, or from 2.59 Å to 2.62 Å.

In the above range, a sufficient distance between lithium and oxygen in the Li slab may be maintained without being excessively separated. Accordingly, the intercalation and deintercalation of lithium may be easily performed in an entire region without a region where the lattice structure of the cathode active material is deactivated, while suppressing collapse of the lattice structure of the cathode active material. Thus, the power properties of the cathode including the cathode active material may be improved.

In some embodiments, the thickness of the Li slab measured by the Rietveld method in the space group R-3m crystal structure model by the XRD analysis of the cathode active material for a lithium secondary battery may be in a range from 2.59 Å to 2.615 Å, or from 2.597 Å to 2.615 Å. In this range, the power properties of the cathode including the cathode active material may be further improved.

In some embodiments, a ratio of a peak intensity of a (003) plane to a peak intensity of a (104) plane calculated from the XRD analysis may be in a range from 2 to 3. In an embodiment, the ratio of the peak intensities may be greater than 2.2 and less than 2.5, greater than 2.2 and less than 2.4, or greater than 2.2 and less than 2.3.

The ratio of the peak intensity of the (003) plane to the peak intensity of the (104) plane may be an indicator of a crystallinity of the cathode active material. When the ratio of the peak intensities is decreased, the cation mixing may be decreased. However, when the ratio of the peak intensities is excessively decreased, the cathode active material may not be stably formed into a hexagonal layered structure. Further, an elution amount of the transition metal or doping elements of the cathode may be increased.

In the above range of the ratio of the peak intensities, deterioration of the life-span and power properties due to an increase in the cation mixing may be suppressed, and the elution amount of the doping elements may be suppressed, thereby improving an initial efficiency and an initial capacity.

In example embodiments, the cathode active material for a lithium secondary battery may include a lithium-nickel-based oxide.

For example, the lithium-nickel-based oxide may further include at least one of cobalt (Co) and manganese (Mn). In an embodiment, the cathode active material may include a Ni—Co—Mn (NCM)-based lithium oxide.

In some embodiments, the cathode active material or the lithium-nickel-based composite oxide may include a layered structure or a crystal structure represented by the following chemical formula 1.

In some embodiments, the cathode active material or the lithium-nickel-based composite oxide may have a layered structure or a crystal structure represented by Chemical Formula 1.

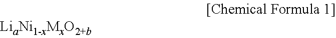

In Chemical Formula 1, 0.8≤a≤1.5, −0.1≤b≤0.1, and 0.02≤x≤0.4. In an embodiment, 0.02≤x≤0.2, 0.02≤x≤0.15, or 0.02≤x≤0.12.

The chemical structure represented by Chemical Formula 1 represents a bonding relationship included in the layered structure or the crystal structure of the cathode active material, and does not exclude other additional elements. For example, M includes Co and/or Mn, and Co and/or Mn may serve as a main active element of the cathode active material together with Ni. Chemical Formula 1 is provided to express the bonding relationship of the main active element and is to be understood as a formula encompassing introduction and substitution of the additional elements.

In an embodiment, an auxiliary element for enhancing chemical stability of the cathode active material or the layered structure/crystal structure in addition to the main active element may be further included. The auxiliary element may be incorporated into the layered structure/crystal structure to form a bond, and this case is to be understood as being included within the range of the chemical structure represented by Chemical Formula 1.

The auxiliary element may include at least one of, e.g., Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr. The auxiliary element may act as an auxiliary active element such as Al that contributes to capacity/power activity of the cathode active material together with Co or Mn.

For example, the cathode active material or the lithium-nickel-based oxide may include a layered structure or a crystal structure represented by Chemical Formula 1-1.

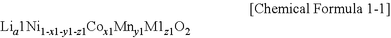

In Chemical Formula 1-1, M1 may include the above-described auxiliary element. In Chemical Formula 1-1, 0.98<a1<1.03, 0.02≤x1≤0.15, 0≤y1≤0.15, and 0≤z1≤0.1. In an embodiment, 0.02<x1≤0.15 and 0≤y1≤0.1. In an embodiment, 0.05<x1≤0.15 and 0<y1≤0.1. In an embodiment, 0.07≤x1≤0.12 and 0.005≤y1≤0.05. In an embodiment, 0.07≤x1≤0.12 and 0.01≤y1≤0.03. In an embodiment, 0.08≤x1≤0.12 and 0.005≤y1≤0.05. In an embodiment, 0.08≤x130.12 and 0.01≤y1≤0.03.

In an embodiment, in Chemical Formula 1-1, x12y1 or x1> y1. For example, in the lithium-nickel-based oxide, a content of cobalt may be higher than that of manganese. Accordingly, a crystal lattice of the R-3m crystal structure may be stably controlled. Thus, collapse of the crystal structure may be suppressed even when nickel is included in a high content.

The cathode active material above may further include a coating element or a doping element. For example, elements substantially the same as or similar to the above-described auxiliary elements may be used as the coating element or the doping element. For example, the above-described elements may be used alone or in a combination of two or more therefrom as the coating element or the doping element.

The doping element of the coating element may be present on a surface of the lithium-nickel-based oxide particle, or may penetrate through the surface of the lithium-nickel-based oxide particle to be included in the bonding structure represented by Chemical Formula 1 or Chemical Formula 1-1.

The above-described cathode active material may be formed through a reaction between a lithium source and a transition metal precursor (e.g., a Ni—Co—Mn hydroxide). In example embodiments, a preliminary lithium-nickel based oxide may be formed by reacting the transition metal precursor with the lithium source.

For example, the transition metal precursor may be prepared through a coprecipitation reaction of metal sources. The metal sources may include a nickel source, a manganese source and a cobalt source.

The nickel source may include, e.g., nickel sulfate, nickel nitrate, nickel acetate, a hydrate thereof, etc. The manganese source may include, e.g., manganese sulfate, manganese acetate, a hydrate thereof, etc. The cobalt source may include, e.g., cobalt sulfate, cobalt nitrate, cobalt carbonate, a hydrate thereof, etc.

The metal sources may be mixed with a precipitating agent and/or a chelating agent to prepare an aqueous solution. The aqueous solution may be coprecipitated in a reactor to prepare the transition metal precursor.

The precipitating agent may include an alkaline compound such as sodium hydroxide (NaOH), sodium carbonate (Na₂CO₃), etc. The chelating agent may include, e.g., ammonia water, ammonium carbonate, etc.

A temperature of the coprecipitation reaction may be controlled, e.g., in a range from about 40° C. to 60° C. A reaction time may be controlled in a range from about 24 hours to 72 hours.

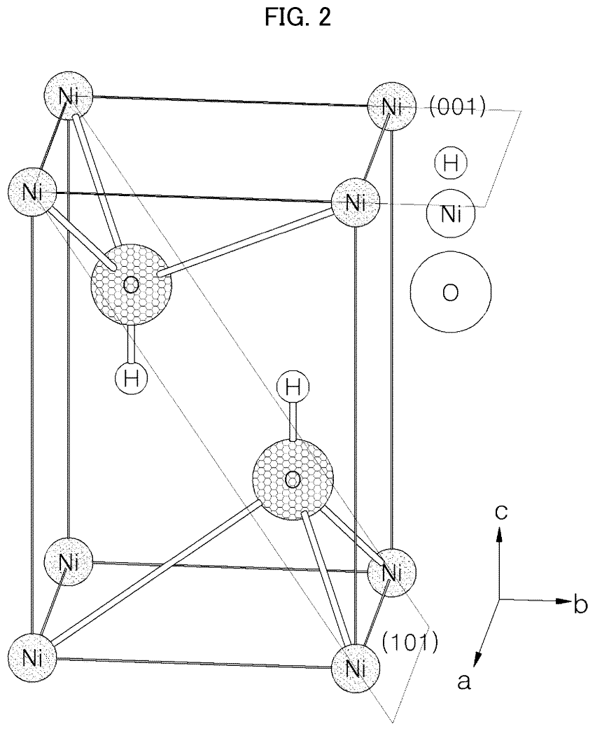

FIG. 2 is a schematic diagram of a crystal structure of a transition metal precursor in accordance with example embodiments. In FIG. 2, Ni is exemplarily shown as the transition metal included in the transition metal precursor.

Referring to FIG. 2, a (001) plane is a plane parallel to a a-b plane including four nickel atoms. A (101) plane is a plane that passes through four nickel atoms and an oxygen atom arranged between the nickel atoms and is inclined toward a c-axis from the a-b plane to contact the (001) plane.

In example embodiments, the transition metal precursor may have a crystallite size in the (001) plane defined by Equation 3 in a range from 20 nm to 100 nm, from 20 nm to 90 nm, or from 20 nm to 80 nm.

$${L}_{001} = \frac{K λ}{{β}_{001} cos θ} \qquad [ Equation 3 ]$$

In Equation 3, L₀₀₁ represents the crystallite size (nm) in the (001) plane, K represents a shape coefficient, λ represents an X-ray wavelength (nm), B₀₀₁ represents a full width at half maximum (rad), and 0 represents a diffraction angle (rad) of a peak of the (001) pane from the XRD analysis. The shape coefficient (K) may be, e.g., 0.8.

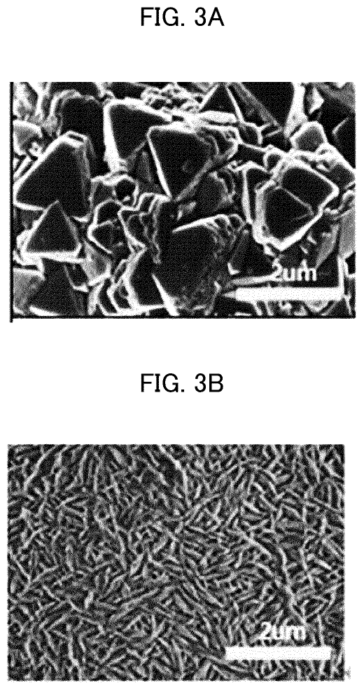

FIG. 3A and FIG. 3B are scanning electron microscopy (SEM) images showing a transition metal precursor according to example embodiments and a transition metal precursor according to a comparative example, respectively.

Specifically, FIG. 3A is an SEM image showing a transition metal precursor when the crystallite size of the transition metal precursor in the (001) plane is in a range from 20 nm to 100 nm. FIG. 3B is an SEM image showing a transition metal precursor when the crystallite size of the transition metal precursor in the (001) plane is less than 20 nm.

Referring to FIGS. 3A and 3B, when the crystallite size of the transition metal precursor in the (001) plane is less than 20 nm, the transition metal precursor may not form a plate-shaped crystallinity, and the transition metal may be easily eluted from the cathode active material. Accordingly, the initial capacity and the initial efficiency of the cathode including the cathode active material may be lowered.

When the crystal size of the (001) plane of the transition metal precursor exceeds 100 nm, pores between transition metal particles at an inside of the transition metal precursor may be increased. Accordingly, microcracks and macrocracks may be caused in the cathode active material, and cracks may occur in the cathode including the cathode active material.

In some embodiments, the transition metal precursor may have the crystallite size of the (001) plane defined by Equation 3 in a range from 20 nm to 60 nm, from 20 nm to 55 nm, or from 25 nm to 55 nm. In the above range, the initial capacity and initial efficiency of the cathode including the cathode active material formed from the transition metal precursor may be further improved, and cracks may be prevented during the production of the cathode active material.

In some embodiments, the transition metal precursor may be prepared by mixing the metal sources in a ratio satisfying the content or concentration ratio of each metal described with reference to Chemical Formula 1. For example, the transition metal precursor may include a compound represented by Chemical Formula 2 below.

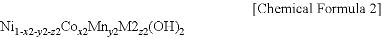

In Chemical Formula 2, M2 may include at least one element selected from Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr.

In Chemical Formula 2, 0.023x2≤0.15, 0≤y2≤0.15, and 0≤z2≤0.1. In some embodiments, 0.02<x2≤0.15 and 0≤y2≤0.1, 0.05<x230.15 and 0<y2≤0.1, 0.07≤x2≤0.12 and 0.005≤y2≤0.05, 0.07≤x2≤0.12 and 0.005≤y2≤0.03, 0.08≤x2≤0.12 and 0.005≤y2≤0.05, or 0.08≤x230.12 and 0.01≤y2≤0.03.

In the above range, the nickel content of the cathode active material may be increased, so that the capacity of the cathode may be increased, and the crystal lattice of the R-3m structure of the cathode active material may be maintained without being collapsed by Co and Mn.

The lithium source may include, e.g., lithium carbonate (Li₂CO₃), lithium nitrate (LiNO₃), lithium acetate (CH₃COOLi), lithium oxide (Li₂O), lithium hydroxide (LiOH), etc. These may be used alone or in a combination of two or more therefrom.

The transition metal precursor and the lithium source may be reacted to form a preliminary lithium-nickel-based oxide. For example, an input molar ratio of the transition metal precursor to the lithium source may be in a range from 0.98 to 1.03 or from 0.985 to 1.025. In the above range, the slab ratio in the cathode active material may be efficiently adjusted in the above-described range.

In some embodiments, the preliminary lithium-nickel-based oxide may be further reacted with a doping element source. For example, the doping element source may include titanium dioxide, titanium butoxide, manganese sulfate hydrate, aluminum hydroxide, magnesium hydroxide, zirconium hydroxide, zirconium dioxide, strontium hydroxide, strontium oxide, barium hydroxide, barium oxide, yttria-stabilized zirconia, tungsten oxide, etc. In an embodiment, the doping element source may include strontium hydroxide, strontium oxide, barium hydroxide and/or barium oxide. These may be used alone or in a combination of two or more therefrom.

In example embodiments, the preliminary lithium-nickel oxide may be heat-treated (calcined) to produce lithium-nickel-based oxide particles having improved crystallinity.

In some embodiments, a temperature of the heat-treatment may be in a range from about 600° C. to 1,000° C., from 600° C. to 850° C., or from 650° C. to 800° C.

In some embodiments, a washing process and a drying process may be further performed on the lithium-nickel-based oxide particles produced as the cathode active material. The washing process may be performed using an aqueous solvent or an organic solvent. Lithium impurities (e.g., Li₂O, Li₂CO₃, etc.) remaining on surfaces of the lithium-nickel-based oxide particles may be removed by the washing process.

In the above-described washing process, doping elements (e.g., Ba, S, Sr, B, W, etc.) may be eluted together with the lithium impurities. Accordingly, the crystal structure of the cathode active material may be collapsed, and the capacity and life-span properties may be deteriorated.

However, the elution of the doping element may be reduced by manufacturing the cathode active material so as to have the crystallite size and the slab ratio as described above.

In some embodiments, a weight ratio of the doping element included in the lithium-nickel-based before the washing and drying to the doping element included in the lithium-nickel-based oxide after the washing and drying may be 0.5 or more, or 0.6 or more. In the above range, the capacity and life-span properties of the cathode including the cathode active material may be further enhanced.

According to embodiments of the present disclosure, a lithium secondary battery including the cathode including the above-described cathode active material for a lithium secondary battery described is provided.

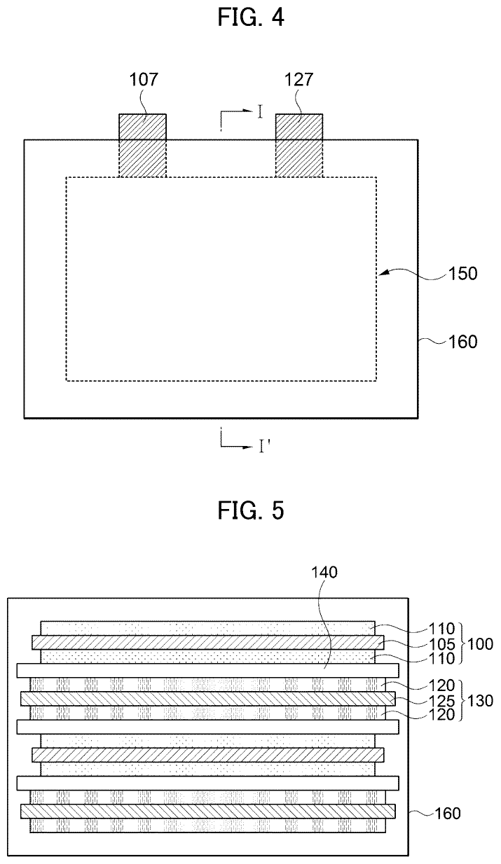

FIG. 4 and FIG. 5 are a schematic plan view and a schematic cross-sectional view, respectively, illustrating a lithium secondary battery in accordance with example embodiments.

Referring to FIGS. 4 and 5, the lithium secondary battery may include a cathode 100 including a cathode active material layer including the above-described cathode active material for a lithium secondary battery and an anode 130 facing the cathode.

The cathode 100 may include a cathode current collector 105 and a cathode active material layer 110 disposed on at least one surface of the cathode current collector 105.

The cathode current collector 105 may include stainless steel, nickel, aluminum, titanium, copper, or an alloy thereof. The cathode current collector 105 may include aluminum or stainless steel surface-treated with carbon, nickel, titanium or silver. For example, a thickness of the cathode current collector 105 may be in a range from 5 μm to 50 μm.

For example, the above-described cathode active material may be mixed in a solvent to prepare a cathode slurry. The cathode slurry on the cathode current collector 105, and the dried and pressed to form the cathode active material layer 110. The coating process may include a gravure coating, a slot die coating, a multi-layered simultaneous die coating, an imprinting, a doctor blade coating, a dip coating, a bar coating, a casting, etc.

The cathode active material layer 110 may further include a binder, and optionally may further include a conductive material, a thickener, etc.

Examples of the solvent used in the manufacture of the cathode active material layer 110 may include N-methyl-2-pyrrolidone (NMP), dimethylformamide (DMF), dimethylacetamide (DMAC), N,N-dimethylaminopropylamine, ethylene oxide, tetrahydrofuran (THF), etc.

The binder may include polyvinylidenefluoride (PVDF), poly(vinylidene fluoride-co-hexafluoropropylene), polyacrylonitrile, polymethylmethacrylate, acrylonitrile butadiene rubber (NBR), polybutadiene rubber (BR), styrene butadiene rubber (SBR), etc.

In an embodiment, a PVDF-based binder may be used as a cathode binder. In this case, an amount of binder for forming the cathode active material layer 110 may be reduced and an amount of the cathode active material may be relatively increased, thereby improving power and capacity of the secondary battery.

The conductive material may be added to enhance a conductivity of the cathode active material layer 110 and/or a mobility of lithium ions or electrons. In a non-limiting example, the conductive material may include a carbon-based conductive material such as graphite, carbon black, acetylene black, Ketjen black, graphene, a carbon nanotube, a vapor-frown carbon fiber (VGCF), a carbon fiber, and/or a metal-based conductive material including tin, tin oxide, titanium oxide, a perovskite material such as LaSrCoO₃ and LaSrMnO₃, etc.

In an embodiment, the cathode active material layer 110 may further include the thickener and/or a dispersive agent. For example, the cathode active material layer 110 may further include the thickener such as carboxymethyl cellulose (CMC).

The anode 130 may include an anode current collector 125 and an anode active material layer 120 disposed on at least one surface of the anode current collector 125.

The anode current collector 125 may include, e.g., a copper foil, a nickel foil, a stainless steel foil, a titanium foil, a nickel foam, a copper foam, a polymer substrate coated with a conductive metal, etc. For example, a thickness of the anode current collector 125 may be in a range from 5 μm to 50 μm.

The anode active material layer 120 may include an anode active material. A material capable of adsorbing and desorbing lithium ions may be used as the anode active material. For example, the anode active material may include a carbon-based material such as a crystalline carbon, an amorphous carbon, a carbon composite, a carbon fiber, etc.; a lithium metal; a lithium alloy; a silicon (Si)-containing material or a tin (Sn)-containing material, etc.

Examples of the amorphous carbon include hard carbon, coke, a mesocarbon microbead (MCMB), a mesophase pitch-based carbon fiber (MPCF), etc.

Examples of the crystalline carbon include a graphite-based carbon such as artificial graphite, natural graphite, a graphitized coke, a graphitized MCMB or a graphitized MPCF.

The lithium metal may include a pure lithium metal or a lithium metal having a protective layer formed thereon for suppressing a dendrite growth, etc. In an embodiment, a lithium metal-containing layer deposited or coated on the anode current collector 125 may be used as the anode active material layer 120. In an embodiment, a lithium thin film layer may be used as the anode active material layer.

Elements included in the lithium alloy may include aluminum, zinc, bismuth, cadmium, antimony, silicon, lead, tin, gallium, indium, etc.

The silicon-containing material may provide increased capacity properties. The silicon-containing material may include silicon (Si), a silicon oxide (SiOx, 0<x<2), a metal-doped SiOx (0<x<2), a silicon-carbon composite, etc. The metal may include lithium and/or magnesium, and the metal-doped SiOx (0<x<2) may include a metal silicate.

For example, the anode active material may be mixed in a solvent to prepare an anode slurry. The anode slurry may be coated/deposited on the anode current collector 125, and then dried and pressed to obtain the anode active material layer 120. For example, the coating process may include a gravure coating, a slot die coating, a multi-layered simultaneous die coating, an imprinting, a doctor blade coating, a dip coating, a bar coating, a casting, etc.

The anode active material layer 120 may further include a binder, and optionally may further include a conductive material, a thickener, etc.

A solvent used in the formation of the anode slurry may include, e.g., water, pure water, deionized water, distilled water, ethanol, isopropanol, methanol, acetone, n-propanol, t-butanol, etc.

Materials that may be used in the formation of the cathode may also be used as the binder, conductive material and thickener.

In some embodiments, a styrene-butadiene rubber (SBR)-based binder, a poly(3,4-ethylenedioxythiophene) (PEDOT)-based binder, etc., may be used as the anode binder.

A separator 140 may be interposed between the cathode 100 and the anode 130. An electrical short-circuiting between the cathode 100 and the cathode 130 may be prevented by the separator while generating an ion flow. In some embodiments, a thickness of the membrane may be in a range from 10 μm to 20 μm, nut is not limited thereto.

For example, the separator 140 may include a porous polymer film prepared from, e.g., a polyolefin-based polymer such as an ethylene homopolymer, a propylene homopolymer, an ethylene/butene copolymer, an ethylene/hexene copolymer, an ethylene/methacrylate copolymer, etc. The separator 140 may also include a non-woven fabric formed from a glass fiber with a high melting point, a polyethylene terephthalate fiber, etc.

The separator 140 may include a ceramic-based material. For example, inorganic particles may be coated on a polymer film or dispersed in the polymer film to improve heat resistance.

The separator 140 may have a single-layered or multi-layered structure including the polymer film and/or the non-woven fabric described above.

In example embodiments, the cathode 100, the anode 130 and the separator 140 may be repeatedly stacked to an electrode assembly 150. In some embodiments, the electrode assembly 150 may be fabricated in the form of a winding-type, a stacking-type or a z-folding type, a stack-folding type, etc.

The electrode assembly 150 may be accommodated together with an electrolyte solution in a case 160 to define the lithium secondary battery. In example embodiments, a non-aqueous electrolyte solution may be used as the electrolyte solution.

The non-aqueous electrolyte may include a lithium salt and an organic solvent. The lithium salt may be represented by Li⁺X⁻, and an anion of the lithium salt X⁻ may include, e.g., F⁻, Cl⁻, Br⁻, I⁻, NO₃⁻, N(CN)₂⁻, BF₄⁻, ClO₄⁻, PF₆⁻, (CF₃)₂PF₄⁻, (CF₃)₃PF₃⁻, (CF₃)₄PF₂⁻, (CF₃)₅PF⁻, (CF₃)₆P⁻, CF₃SO₃⁻, CF₃CF₂SO₃⁻, (CF₃SO₂)₂N⁻, (FSO₂)₂N⁻, CF₃CF₂(CF₃)₂CO⁻, (CF₃SO₂)₂CH⁻, (SF₅)₃C⁻, (CF₃SO₂)₃C⁻, CF₃(CF₂)₇SO₃⁻, CF₃CO₂⁻, CH₃CO₂⁻, SCN⁻, (CF₃CF₂SO₂)₂N⁻, etc.

The organic solvent may include an organic compound that may have a sufficient solubility for the lithium salt and an additive and may not have a reactivity in the battery. For example, the organic solvent may include a carbonate solvent, an ester solvent, an ether solvent, a ketone solvent, an alcohol solvent and/or an aprotic solvent.

Examples of the organic solvent include propylene carbonate (PC), ethylene carbonate (EC), butylene carbonate, diethyl carbonate (DEC), dimethyl carbonate (DMC), ethyl methyl carbonate (EMC), methylpropyl carbonate, dipropyl carbonate, vinylene carbonate, methyl acetate (MA), ethyl acetate (EA), n-propyl acetate (n-PA), 1,1-dimethylethyl acetate (DMEA), methyl propionate (MP), ethyl propionate (EP), fluoroethyl acetate (FEA), difluoroethyl acetate (DFEA), trifluoroethyl acetate (TFEA), dibutyl ether, tetraethylene glycol dimethyl ether (TEGDME), diethylene glycol dimethyl ether (DEGDME), dimethoxyethane, tetrahydrofuran (THF), 2-methyltetrahydrofuran, ethyl alcohol, isopropyl alcohol, dimethyl sulfoxide, acetonitrile, dimethoxyethane, diethoxyethane, sulfolane, gamma-butyrolactone, propylene sulfite, etc. These may be used alone or in a combination of two or more therefrom.

The non-aqueous electrolyte solution may further include the additive. The above additive may include, e.g., a cyclic carbonate-based compound, a fluorine-substituted carbonate-based compound, a sultone-based compound, a cyclic sulfate-based compound, a cyclic sulfite-based compound, a phosphate-based compound and/or a borate-based compound.

The cyclic carbonate-based compound may include vinylene carbonate (VC), vinyl ethylene carbonate (VEC), etc.

The fluorine-substituted cyclic carbonate-based compound may include fluoroethylene carbonate (FEC).

The sultone-based compound may include 1,3-propane sultone, 1,3-propene sultone, 1,4-butane sultone, etc.

The cyclic sulfate-based compound may include 1,2-propylene sulfate.

The cyclic sulfite-based compound may include ethylene sulfite, butylene sulfite, etc.

The phosphate-based compound may include lithium difluorobis-oxalato phosphate, lithium difluorophosphate, etc.

The borate-based compound may include lithium bis(oxalate) borate.

As illustrated in FIG. 4, electrode tabs (a cathode tab and an anode tab) may protrude from the cathode current collector 105 and the anode current collector 125 included in each electrode cell to one side of the case 160. The electrode tabs may be welded together with the one side of the case 160 to be connected to an electrode lead (a cathode lead 107 and an anode lead 127) that may be extended or exposed to an outside of the case 160.

The lithium secondary battery may be manufactured in, e.g., a cylindrical shape using a can, a prismatic shape, a pouch shape or a coin shape.

According to example embodiments, the lithium secondary battery may include the lithium-nickel-based oxide particles containing a high nickel content and having the above-described crystallite size and thickness ratio of the TM slab and the Li slab. Accordingly, the lithium secondary battery having improved chemical stability of the cathode active material, improved capacity, life-span and long-term stability can be realized while suppressing cation mixing/defects.

Hereinafter, experimental examples including specific examples are proposed to more concretely describe the present disclosure. However, the following examples are only given for illustrating the present disclosure and those skilled in the related art will obviously understand that various alterations and modifications are possible within the scope and spirit of the present disclosure. Such alterations and modifications are duly included in the appended claims.

### Examples and Comparative Examples

### Example 1

### (1) Preparation of Cathode Active Material

NiSO₄, CoSO₄ and MnSO₄ were mixed in a mass ratio of 88:10:2 by using distilled water bubbled with N₂ for 24 hours to remove dissolved oxygen. The solution was added to a reactor at 50° C., and NaOH and NH₃H₂O were coprecipitated for 48 hours using a precipitating agent and a chelating agent to obtain a transition metal precursor. The obtained transition metal precursor was dried at 80° C. for 12 hours and then re-dried at 110° C. for 12 hours. The obtained transition metal precursor was Ni_{0.92}Co_{0.07}Mn_{0.01}(OH)₂.

Lithium hydroxide as a lithium source and the transition metal precursor were mixed so that a molar ratio of lithium to the transition metal precursor became 1.015, and then strontium hydroxide and barium hydroxide were additionally mixed as doping element sources and reacted. The mixture was placed in a firing furnace and heated to 670° C. to 710° C. at a ramping rate of 2° C./min, and maintained at 710° C. for 10 hours while continuously passing oxygen at a flow rate of 20 L/min. After the firing, natural cooling was performed to room temperature, and a lithium-nickel-based oxide was obtained by pulverization and classification. Thereafter, the lithium-nickel-based oxide was washed and dried to obtain a cathode active material.

### (2) Fabrication of Secondary Battery

A lithium secondary battery was manufactured using the obtained cathode active material. Specifically, a cathode slurry was prepared by mixing the cathode active material, Denka Black as a conductive material and PVDF as a binder in a mass ratio of 97:2:1, respectively. The prepared cathode slurry was coated on an aluminum current collector, and then dried and pressed to prepare a cathode.

An anode slurry containing 93 wt % of natural graphite as an anode active material, 5 wt % of KS6 as a flake type conductive agent, 1 wt % of styrene-butadiene rubber (SBR) as a binder, and 1 wt % of carboxymethyl cellulose (CMC) as a thickener was prepared. The anode slurry was coated on a copper substrate, dried, and pressed to prepare an anode.

15 sheets of the cathode and 16 sheets of the anode were notched and stacked, and a separator (polyethylene, thickness: 25 μm) was interposed between the cathode and anode to form a 20 Ah electrode cell. Tab portions of the cathodes and the anodes were welded. The welded cathode/separator/anode assembly was placed in a pouch, and three sides except for an electrolyte injection side were sealed. A region around the tab portions was included in the sealed portion. An electrolyte solution was injected through the electrolyte injection side, and then the electrolyte injection side was also sealed. Subsequently, impregnation was performed for 12 hours or more.

LiPF₆ was dissolved in a mixed solvent of EC/EMC/DEC (25/45/30; volume ratio) to have a concentration of 1 M, and 1 wt % of vinylene carbonate (VC), 0.5 wt % of 1,3-propene sultone (PRS) and 0.5 wt % of lithium bis(oxalato) borate (LiBOB) were added to prepare the electrolyte solution.

### Examples 2 to 12 and Comparative Examples 1 to 6

A secondary battery was manufactured by the same method as that in Example 1, except that the mixing ratio of the lithium source and the transition metal precursor, the firing temperature and the doping element content were adjusted as shown in Table 1 below.

### (3) Measurement of Ba and Sr Contents Before and After Washing

Ba and Sr contents of the lithium-nickel oxides of Examples and Comparative Examples before the washing and drying, and Ba and Sr contents of the cathode active materials after the washing and drying were measured using an inductively coupled plasma optical emission spectroscopy (ICP-OES). The measurement results are shown in Table 1 below.

TABLE 1

| | conditions of | | | | | | reduction | |
|---|---|---|---|---|---|---|---|---|
| | mixing and firing | | | | | | ratio of | |
| | molar ratio of | | doping element content | | | | doping | |
| | lithium to | firing | before washing | | after washing | | element | |
| | transition | temperature | Ba | Sr | Ba | Sr | Ba | Sr |
| | metal precursor | (° C.) | (ppm) | (ppm) | (ppm) | (ppm) | (%) | (%) |
| Example 1 | 1.015 | 710 | 498 | 502 | 381 | 287 | −23 | −43 |
| Example 2 | 1.015 | 700 | 490 | 512 | 375 | 294 | −23 | −43 |
| Example 3 | 1.015 | 720 | 489 | 499 | 380 | 271 | −22 | −46 |
| Example 4 | 1.015 | 710 | 503 | 1008 | 381 | 590 | −24 | −41 |
| Example 5 | 1.015 | 710 | 998 | 500 | 808 | 309 | −19 | −38 |
| Example 6 | 1.025 | 710 | 503 | 499 | 370 | 288 | −26 | −42 |
| Example 7 | 0.995 | 710 | 505 | 485 | 375 | 279 | −26 | −42 |
| Example 8 | 0.985 | 710 | 496 | 507 | 382 | 284 | −23 | −44 |
| Example 9 | 1.015 | 710 | 494 | 482 | 306 | 229 | −38 | −52 |
| Example 10 | 1.015 | 710 | 509 | 492 | 275 | 187 | −46 | −62 |
| Example 11 | 1.015 | 710 | 491 | 501 | 403 | 311 | −18 | −38 |
| Example 12 | 1.015 | 710 | 488 | 481 | 410 | 308 | −16 | −36 |
| Comparative | 1.015 | 710 | 499 | 489 | 210 | 90 | −58 | −82 |
| Example 1 | | | | | | | | |
| Comparative | 1.015 | 710 | 509 | 511 | 209 | 79 | −59 | −85 |
| Example 2 | | | | | | | | |
| Comparative | 0.975 | 710 | 493 | 481 | 365 | 254 | −26 | −47 |
| Example 3 | | | | | | | | |
| Comparative | 1.035 | 710 | 509 | 511 | 371 | 248 | −27 | −51 |
| Example 4 | | | | | | | | |
| Comparative | 1.015 | 740 | 512 | 500 | 370 | 240 | −28 | −52 |
| Example 5 | | | | | | | | |
| Comparative | 1.015 | 690 | 500 | 495 | 222 | 100 | −56 | −80 |
| Example 6 | | | | | | | | |

### (4) XRD Analysis

### 1) Measurement of Crystallite Size of (001) Plane of Transition Metal Precursor

A crystallite size of a (001) plane of each transition metal precursor of Examples and Comparative Examples was calculated using an XRD diffraction analysis and Equation 3.

$${L}_{001} = \frac{K λ}{{β}_{001} cos θ} \qquad [ Equation 3 ]$$

In Equation 3, L₀₀₁ represents the crystallite size (nm) in the (001) plane, K represents a shape coefficient (0.8), 2 represents an X-ray wavelength (nm), β₀₀₁ represents a full width at half maximum (rad) and 0 represents a diffraction angle (rad) of a peak of the (001) pane from the XRD analysis.

### 2) Measurement of Crystallite Size of (104) Plane

A crystallite size of a (104) plane was calculated using the XRD diffraction analysis and Equation 1 below for the cathode active materials of Examples and Comparative Examples.

$${L}_{104} = \frac{K λ}{{β}_{104} cos θ} \qquad [ Equation 1 ]$$

In Equation 1, L₁₀₄ represents the crystallite size (nm) in the (104) plane, K represents a shape coefficient (0.8), 2 represents an X-ray wavelength (nm), β₁₀₄ represents a full width at half maximum (rad), and 0 represents a diffraction angle (rad) of a peak of the (104) plane from the XRD analysis. The shape coefficient (K) may be, e.g., 0.8.

### 3) Measurement of Thickness of Li Slab Layer

A thickness of a Li slab was measured by performing a crystal structure analysis by a Rietveld method using a space group R-3m through an XRD diffraction analysis in a crystal structure model for each cathode active material of Examples and Comparative Examples. Specifically, the Rietveld method analysis was performed using a high score program.

### 4) Measurement of Thickness of TM Slab

A thickness of a TM slab was measured by performing a crystal structure analysis by a Rietveld method using a space group R-3m through an XRD diffraction analysis in a crystal structure model for each cathode active material of Examples and Comparative Examples. Specifically, the Rietveld method analysis was performed using a high score program.

### 5) Measurement of Slab Ratio

The measured thicknesses of the Li slab and TM slab of the cathode active materials of Examples and Comparative Examples were substituted into Equation 2 below to measure a slab ratio.

$$slab ratio = ( thickness of TM slab ) / \{ ( Thickness of Li slab ) + ( thickness of TM slab ) \} \qquad [ Equation 2 ]$$

### 6) Measurement of Peak Intensity Ratio

A ratio of a peak intensity of the (003) plane to a peak intensity of the (104) plane was measured by performing a crystal structure analysis by a Rietveld method using a space group R-3m through an XRD diffraction analysis in a crystal structure model for each cathode active material of Examples and Comparative Examples. Specifically, the Rietveld method analysis was performed using a high score program.

Specific XRD analysis equipment/conditions are shown in Table 2 below.

TABLE 2
XRD(X-Ray Diffractometer) EMPYREAN
(manufactured by Malvern-panalytical)

| Maker | PANalytical | |
|---|---|---|
| Anode material | Cu | |
| K-Alpha1 wavelength | 1.540598 | Å |
| Generator voltage | 45 | kV |
| Tube current | 40 | mA |

| | |
|---|---|
| Scan Range | 10~120° |
| Scan Step Size | 0.0065° |
| Divergence slit | ¼° |
| Antiscatter slit | 1° |

The measured results are shown in Table 3 below.

TABLE 3

| | crystallite size (nm) | | | | | |
|---|---|---|---|---|---|---|
| | | active | active material slab property | | | |
| | precursor | material | TM slab | Li slab | | peak intensity |
| | (001) plane | (104) plane | (Å) | (Å) | slab ratio | ratio |
| Example 1 | 26 | 85 | 2.116 | 2.615 | 0.447 | 2.23 |
| Example 2 | 26 | 73 | 2.119 | 2.591 | 0.450 | 2.11 |
| Example 3 | 26 | 93 | 2.111 | 2.601 | 0.448 | 2.21 |
| Example 4 | 26 | 90 | 2.118 | 2.613 | 0.448 | 2.25 |
| Example 5 | 26 | 84 | 2.119 | 2.614 | 0.448 | 2.58 |
| Example 6 | 26 | 91 | 2.125 | 2.609 | 0.449 | 2.15 |
| Example 7 | 26 | 79 | 2.118 | 2.600 | 0.449 | 2.17 |
| Example 8 | 26 | 70 | 2.119 | 2.597 | 0.449 | 2.21 |
| Example 9 | 23 | 78 | 2.121 | 2.605 | 0.449 | 2.07 |
| Example 10 | 21 | 71 | 2.127 | 2.601 | 0.450 | 2.01 |
| Example 11 | 50 | 89 | 2.112 | 2.754 | 0.434 | 2.03 |
| Example 12 | 55 | 94 | 2.111 | 2.764 | 0.433 | 2.05 |
| Comparative | 18 | 60 | 2.138 | 2.595 | 0.452 | 1.06 |
| Example 1 | | | | | | |
| Comparative | 15 | 63 | 2.144 | 2.582 | 0.454 | 1.03 |
| Example 2 | | | | | | |
| Comparative | 26 | 65 | 2.125 | 2.590 | 0.451 | 2.02 |
| Example 3 | | | | | | |
| Comparative | 26 | 95 | 2.138 | 2.595 | 0.452 | 1.88 |
| Example 4 | | | | | | |
| Comparative | 26 | 103 | 2.118 | 2.596 | 0.449 | 1.85 |
| Example 5 | | | | | | |
| Comparative | 26 | 59 | 2.124 | 2.584 | 0.451 | 1.09 |
| Example 6 | | | | | | |

### Experimental Example

### (1) Measurement of Discharge Capacity

The lithium secondary batteries manufactured according to the above-described Examples and Comparative Examples were charged (CC-CV ⅓C 4.2V 0.05C CUT-OFF) in a 25° C. chamber, and then discharged (CC ⅓C 2.5V CUT-OFF) to measure a battery discharge capacity.

### (2) Measurement of Rate Property

The lithium secondary batteries manufactured according to the above-described Examples and Comparative Examples were charged (CC-CV 0.5C 4.2V 0.05C CUT-OFF) in a 25° C. chamber, and then discharged (CC 0.5C 2.5V CUT-OFF) to measure a battery capacity (an initial discharge capacity).

The measured 0.5C discharge capacity was divided by the measured 2C discharge capacity, and the value was converted into a percentage (%) to evaluate a rate property.

### (3) Measurement of Capacity Retention (Life-Span Property) During Repeated Charge and Discharge

For the lithium secondary batteries according to the above-described Examples and Comparative examples, charge (CC-CV 0.66C 4.155V 0.05C CUT-OFF) and discharge (CC 0.66C 2.5V CUT-OFF) were repeated by 800 cycles. A discharge capacity retention was evaluated as a percentage of ae discharge capacity at the 800th cycle relative to a discharge capacity at the 1st cycle.

### (4) Measurement of Ba and Sr Contents Before and After Cell Evaluation

For the lithium secondary batteries according to the above-described examples and comparative examples, Ba and Sr contents of the cathode active material before and after the capacity retention evaluation were measured using an inductively coupled plasma optical emission spectroscopy (ICP-OES).

### (5) Measurement of Peak Intensity Ratio

After evaluating the capacity retention for the lithium secondary batteries according to the above-described Examples and Comparative Examples, a ratio of a peak intensity of the (003) plane to a peak intensity of the (104) plane was measured by performing a crystal structure analysis by a Rietveld method using a space group R-3m through an XRD diffraction analysis in a crystal structure model for each cathode active material of Examples and Comparative Examples. Specifically, the Rietveld method analysis was performed using the high score program, and the XRD analysis equipment/conditions were as shown in Table 2 above.

The evaluation results are shown in Table 4 below.

TABLE 4

| | | rate | | reduction | | |
|---|---|---|---|---|---|---|
| | discharge | property | capacity | ratio of doping | | peak |
| | capacity | (2 C/0.5 C) | retention | element (%) | | intensity |
| | (mAh/g) | (%) | (%) | Ba | Sr | ratio |
| Example 1 | 202.1 | 76 | 88 | −10 | −15 | 3.12 |
| Example 2 | 200.9 | 75 | 89 | −12 | −16 | 3.13 |
| Example 3 | 203.6 | 75 | 75 | −12 | −14 | 2.94 |
| Example 4 | 202.9 | 71 | 87 | −11 | −11 | 3.55 |
| Example 5 | 201.1 | 70 | 81 | −16 | −15 | 2.52 |
| Example 6 | 201.8 | 62 | 85 | −19 | −21 | 1.95 |
| Example 7 | 199.9 | 70 | 82 | −17 | −20 | 2.11 |
| Example 8 | 198.1 | 61 | 80 | −20 | −25 | 1.73 |
| Example 9 | 201.1 | 70 | 79 | −14 | −19 | 2.36 |
| Example 10 | 199.6 | 65 | 70 | −20 | −23 | 1.81 |
| Example 11 | 204.3 | 76 | 86 | −10 | −13 | 3.08 |
| Example 12 | 204.8 | 75 | 88 | −9 | −12 | 2.99 |
| Comparative | 196.7 | 60 | 55 | −28 | −31 | 1.32 |
| Example 1 | | | | | | |
| Comparative | 194.7 | 55 | 51 | −34 | −40 | 1.05 |
| Example 2 | | | | | | |
| Comparative | 195.4 | 48 | 62 | −26 | −31 | 1.37 |
| Example 3 | | | | | | |
| Comparative | 201.5 | 49 | 65 | −25 | −30 | 1.42 |
| Example 4 | | | | | | |
| Comparative | 203.1 | 62 | 45 | −36 | −39 | 1.04 |
| Example 5 | | | | | | |
| Comparative | 194.1 | 45 | 68 | −20 | −27 | 1.66 |
| Example 6 | | | | | | |

Referring to Tables 3 and 4, in Examples where the crystallite size of the cathode active material in the (104) plane was in a range from 70 nm to 100 nm, the crystallite size of the transition metal precursor in the (001) plane was in a range from 20 nm to 100 nm and the slab ratio was 0.45 or less, the rate property of the secondary battery were 60% or more and the capacity retention was 70% or more. Further, the total reduction ratio of the doping element was 50% or less.

Referring to Table 1, in Examples 4 and 5 where the total doping amount before washing was increased, the doping content reduction ratio according to the washing of the lithium-nickel oxide was decreased.

In Example 6 where the lithium source content was increased when mixing the lithium source and the transition metal precursor, the peak intensity ratio of the cathode active material was decreased, but the rate property of the lithium secondary battery was lowered.

In Examples 7 and 8, where the lithium source content was reduced when mixing the lithium source and the transition metal precursor, the discharge capacity and the rate properties of the lithium secondary battery were lowered.

In Examples 9 and 10 where the crystallite size in the (001) plane of the transition metal precursor was reduced, the slab ratio and the eluted amount of the doping elements were slightly increased, and the capacity retention of the lithium secondary battery was relatively lowered.

In Examples 11 and 12 where the slab ratio was within the range of 0.42 to 0.44, the eluted amount of the doping elements was relatively decreased and the discharge capacity was relatively increased.

In Comparative Examples where the crystallite size in the (104) plane of the cathode active material was less than 70 nm or the slab ratio exceeded 45%, the rate property of the lithium secondary battery were 60% or less and the capacity retention was less than 70%. Further, the total reduction ratio of the doping element by to the washing of the lithium-nickel oxide exceeded 45%.

In Comparative Examples 1 and 2 where the crystallite size in the (104) plane of the cathode active material was less than 70 nm, the slab ratio exceeded 45% and the crystallite size in the (001) plane of the transition metal precursor was less than 20 nm, the discharge capacity of the lithium secondary battery was decreased and the rate property and the capacity retention were deteriorated. Further, the doping element reduction ratio was increased according to the washing of the lithium-nickel-based oxide.

In Comparative Example 3 where the crystallite size in the (104) plane of the cathode active material was less than 70 nm, the slab ratio exceeded 45% and the content of the lithium source was reduced when mixing the lithium source and the transition metal precursor, the discharge capacity of the lithium secondary battery was decreased and the rate property and the capacity retention were deteriorated.

In Comparative Example 4 where the crystallite size in the (104) plane of the cathode active material was 70 nm or more, but the slab ratio exceeded 45%, the discharge capacity of the lithium secondary battery was 200 mAh/g or more, but the rate property and the capacity retention were deteriorated.

In Comparative Example 5 where the crystallite size in the (104) plane of the cathode active material exceeded 100 nm due to an increase of the firing temperature, the discharge capacity of the lithium secondary battery was 200 mAh/g or more, but the rate property and the capacity retention were degraded. Further, the total reduction ratio of the doping element due to the washing of the lithium-nickel-based oxide exceeded 70%.

In Comparative Example 6 where the crystallite size in the (104) plane of the cathode active material was less than 70 nm and the slab ratio exceeded 45% due to the reduction of the firing temperature, the discharge capacity of the lithium secondary battery was reduced, and the rate property and the capacity retention were degraded.

What is claimed is:

1. A cathode active material for a lithium secondary battery having a structure of a lithium-nickel-based oxide, wherein a crystallite size in a (104) plane defined by Equation 1 is in a range from 50 nm to 100 nm, and a slab ratio defined by Equation 2 is in a range from 0.4 to 0.45:
$${L}_{104} = \frac{K λ}{{β}_{104} cos θ} \qquad [ Equation 1 ]$$
wherein, in Equation 1, L₁₀₄ represents the crystallite size (nm) in the (104) plane, K represents a shape coefficient, λ represents an X-ray wavelength (nm), β₁₀₄ represents a full width at half maximum (rad), and θ represents a diffraction angle (rad) of a peak of the (104) plane from an X-ray diffraction (XRD) analysis,
$$slab ratio = ( thickness of TM slab ) / \{ ( Thickness of Li slab ) + ( thickness of TM slab ) \} \qquad [ Equation 2 ]$$
wherein, in Equation 2, TM represents a transition metal, the TM slab is an O-TM-O layer measured by a Rietveld method in a space group R-3m crystal structure by the XRD analysis, and
the Li slab is an O—Li—O layer measured by the Rietveld method in the space group R-3m crystal structure by the XRD analysis.

2. The cathode active material for a lithium secondary battery of claim 1, wherein the slab ratio is in a range from 0.42 to 0.44.

3. The cathode active material for a lithium secondary battery of claim 1, wherein the lithium-nickel oxide has a layered structure or crystal structure represented by Chemical Formula 1-1: 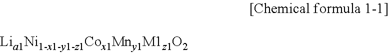
wherein, in Chemical Formula 1-1, M1 includes at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr, and
$$0.98 < a 1 < 1.03 , 0.02 \leq x 1 \leq 0.15 , 0 \leq y 1 \leq 0.15 and 0 \leq z 1 \leq 0.1 .$$

4. The cathode active material for a lithium secondary battery of claim 3, wherein, in Chemical Formula 1-1, 0.05<x1≤0.15 and 0<y1≤0.1.

5. The cathode active material for a lithium secondary battery of claim 3, wherein, in Chemical Formula 1-1, x1>y1.

6. The cathode active material for a lithium secondary battery of claim 1, wherein the thickness of the TM slab is 2.10 Å or more and less than 2.13 Å.

7. The cathode active material for a lithium secondary battery of claim 1, wherein the thickness of the Li slab is 2.59 Å to 2.77 Å.

8. The cathode active material for a lithium secondary battery of claim 1, wherein a ratio of a peak intensity of a (003) plane to a peak intensity of the (104) plane by the XRD analysis is in a range from 2 to 3.

9. The cathode active material for a lithium secondary battery of claim 1, wherein a ratio of a peak intensity of a (003) plane to a peak intensity of the (104) plane by the XRD analysis is greater than 2.2 and 2.5 or less.

10. The cathode active material for a lithium secondary battery of claim 1, wherein the lithium-nickel-based oxide includes a doping element including at least one of Ba, S, Sr, B and W.

11. A lithium secondary battery, comprising:
a cathode comprising a cathode active material layer that includes the cathode active material for a lithium secondary battery according to claim 1; and
an anode facing the cathode.

12. A method for preparing a cathode active material for a lithium secondary battery, comprising:
reacting a lithium source and a transition metal precursor having a crystallite size in a (001) plane defined by Equation 3 of 20 nm to 100 nm to form a preliminary lithium-nickel-based oxide; and
calcining the preliminary lithium-nickel-based oxide to form a lithium-nickel-based oxide:
$${L}_{001} = \frac{K λ}{{β}_{001} cos θ} \qquad [ Equation 3 ]$$
wherein, in Equation 3, L₀₀₁ represents the crystallite size (nm) in the (001) plane, K represents a shape coefficient, λ represents an X-ray wavelength (nm), β₀₀₁ represents a full width at half maximum (rad), and θ represents a diffraction angle (rad) of a peak of the (001) plane from an X-ray diffraction (XRD) analysis.

13. The method of claim 12, wherein the transition metal precursor comprises a compound represented by Chemical Formula 2: 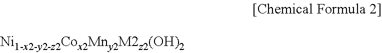
wherein, in Chemical Formula 2, M2 includes at least one selected from the group consisting of Na, Mg, Ca, Y, Ti, Hf, V, Nb, Ta, Cr, Mo, W, Fe, Cu, Ag, Zn, B, Al, Ga, C, Si, Sn, Sr, Ba, Ra, P and Zr, and
$$0.02 \leq x 2 \leq 0.15 , 0 \leq y 2 \leq 0.15 and 0 \leq z 2 \leq 0.1 .$$

14. The method of claim 12, further comprising washing and drying the lithium-nickel-based oxide.

15. The method of claim 14, wherein the lithium-nickel-based oxide comprises a doping element including at least one of Ba, S, Sr, B and W, and
a ratio of a weight of the doping element in the lithium-nickel-based oxide before the washing and drying to a weight of the doping element in the lithium-nickel-based oxide after the washing and drying is 0.5 or more.

16. The method of claim 12, wherein a molar ratio of the transition metal precursor to the lithium source input in the formation of the preliminary lithium-nickel-based oxide is in a range from 0.98 to 1.03.

17. The method of claim 12, wherein a crystallite size in a (104) plane defined by Equation 1 of the lithium-nickel-based oxide is in a range from 50 nm to 100 nm:
$${L}_{104} = \frac{K λ}{{β}_{104} cos θ} \qquad [ Equation 1 ]$$
wherein, in Equation 1, L₁₀₄ represents the crystallite size (nm) in the (104) plane, K represents a shape coefficient, λ represents an X-ray wavelength (nm), β₁₀₄ represents a full width at half maximum (rad), and θ represents a diffraction angle (rad) of a peak of the (104) plane from the XRD analysis.

18. The method of claim 12, wherein a slab ratio defined by Equation 2 of the lithium-nickel-based oxide is in a range from 0.4 to 0.45:
$$slab ratio = ( thickness of TM slab ) / \{ ( Thickness of Li slab ) + ( thickness of TM slab ) \} \qquad [ Equation 2 ]$$
wherein, in Equation 2, TM represents a transition metal, the TM slab is an O-TM-O layer measured by a Rietveld method in a space group R-3m crystal structure by the XRD analysis, and
the Li slab is an O—Li—O layer measured by the Rietveld method in the space group R-3m crystal structure by the XRD analysis.
